(19) United States
(12) Patent Application Publication
(10) Pub. No.: US 2003/0172222 A1
(43) Pub. Date: Sep. 11, 2003

(54) Data-transmission control method

(75) Inventors: Jiin Lai, Taipei (TW); Chau-Chad Tsai, Taipei (TW); Chi-Che Tsai, Kaohsiung (TW); Andrew Su, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: VIA TECHNOLOGIES, INC., Taipei (TW)

(21) Appl. No.: 10/339,984

(22) Filed: Jan. 10, 2003

(30) Foreign Application Priority Data
Mar. 5, 2002 (TW) 091104067

(51) Int. Cl. G06F 13/36

(52) U.S. Cl. 710/315; 710/310

(57) ABSTRACT

A data-transmission control method is disclosed. The method is adapted to be used in a system including a master device, an adapter device, a controlled device, a first bus communicating the master device with the adapter device, a second bus communicating the controlled device with the adapter device, and a data buffer associated with the adapter device. A first and a second data-reading requests are asserted via the second bus by the adapter device in response to a reading transaction actuated via the first bus by the master device. The first and the second data-reading requests have therebetween a time interval that is greater than zero but less than a latency period indicating when the adapter device asserts the first data-reading request to the controlled device and then receives a required first data to have the first bus ready. The first data is stored into the data buffer via the second bus by the controlled device in response to the first data-reading request. The first data is completely stored into the data buffer before the end of the latency period, and is outputted to the master device via the first bus at a pop rate by the data buffer after the latency period is up.

### FIELD OF THE INVENTION

The present invention relates to a data-transmission control method, and more particularly to a data-transmission control method for use in a computer main board.

### BACKGROUND OF THE INVENTION

FIG. 1 is a functional block diagram schematically showing a conventional circuitry in a computer main board. A chipset 11 is electrically connected to a CPU 10, a memory 13, and further to a PCI (Peripheral Connect Interface) slot 12 via a PCI bus 121 and an AGP (Accelerated Graphics Port) slot 14 via an AGP bus 141.

In order to speed up the transmission rate between the chipset 11 and a VGA card positioned at the AGP slot 14, the data transmission rate on the AGP bus 141 is generally twice or more of that on the PCI bus 121. For a main board of a server computer or a computer for industrial purposes, however, the speed for the operation of image data and display of image is not as critical as in a personal computer. Frequently, the AGP slot 14 is idle. Therefore, an extensive structure as shown in FIG. 2 is developed to make use of the AGP slot.

Referring to FIG. 2, additional PCI slots 16 can be provided by the interfacing of an adapter chip 15, e.g. a VPX chip, between the PCI slots 16 and the AGP bus 141, thereby allowing more peripheral devices to be connected to the system. Therefore, the master device 17 reads data from the chipset 11 via the PCI bus 161, the adapter chip 15 and the AGP bus 141. The adapter chip 15 asserts a data-reading request to the chipset 11. The chipset 11 then seaches the required data from the cache memory of the central processing unit 10 or dynamic random access memory (DRAM) 13 in response to the request, and reads and transfers the data to the adapter chip 15 to prepare the PCI bus 161. It is apparent that a certain period of time is needed for completing such process. A maximum value of the period is referred to as a latency period. In order to make use of the latency period, a data buffer 151 is provided in the adapter chip 15 in the prior art to store the data fetched by the adapter chip 15 during the latency period.

An example is given as follows. It is assumed that the latency period has a length of 16 clock cycles, the data length to be fetched in response to each request is 8 quadruple word (hereinafter, “QW”), and the rate for the data buffer 151 to transfer the data to the PCI bus 161, or data pop rate, is 1 QW per clock cycle. In order to assure of the high efficiency during the transfer process, the capacity of the data buffer 151 in the prior art is made equal to the product of the data pop rate and the latency period. In this example, the selected capacity of the data buffer 151 is 16 QW.

Please refer to FIG. 3 which is a sequential waveform diagram schematically showing the signals associated with the data transfer of the devices of FIG. 2. When the signals FRAME and IRDY asserted by the master device 17 to the PCI bus 161 are switched from a high level to a low level, it means the master device 17 starts a read transaction and is ready for receiving data. The adapter chip 15 then asserts a device selection signal DEVSEL to the PCI bus 161 and two continuous data-reading requests (the first high PMADS) to the AGP bus 141. By this way, data of 16 QW in length is fetched from the chipset 11 to the data buffer 151 via the AGP bus 141. When the data buffer 151 in the adapter chip 15 receives the data of 16 QW in length after the 16 clock cycles of latency period, referring to the first high PMRDY, the adapter chip 15 informs the PCI bus 161 of the ready status by switching the TRDY signal from a high level to a low level. Meanwhile, the data is transferred from the data buffer 151 to the master device 17 via the PCI bus 161 at a transmission rate of 1 QW per clock cycle. Subsequently, the adapter chip 15 asserts another data-reading request (the second, third, fourth or fifth high PMADS) to the AGP bus 14 every 8 clock cycles to fetch data of 8 QW in length from the chipset 11 to the data buffer 151 via the AGP bus 141. The adapter chip 15 thus continuously transfers data to the master device 17 via the PCI bus 161 at high efficiency.

In the near future, it is expetced the data pop rate will be getting higher and higher. Therefore, the size of the data buffer 151 built in the adapter buffer 15 needs to be enlarged accordingly. The cost, of course, increases.

### SUMMARY OF THE INVENTION

Therefore, an object of the present invention is to provide a data-transmission control method, which maintains a high data-transmission efficiency under a limited size of the data buffer.

An aspect of the present invention relates to a data-transmission control method for use in a system comprising a master device, an adapter device, a controlled device, a first bus communicating the master device with the adapter device, a second bus communicating the controlled device with the adapter device, and a data buffer associated with the adapter device. The method comprises steps of: asserting a first and a second data-reading requests via the second bus by the adapter device in response to a reading transaction actuated via the first bus by the master device, wherein the first and the second data-reading requests have therebetween a time interval that is greater than zero but less than a latency period indicating when the adapter device asserts the first data-reading request to the controlled device and then receives a required first data to have the first bus ready; storing the first data into the data buffer via the second bus by the controlled device in response to the first data-reading request, and completing storing the first data before the end of the latency period; and ouputting the first data to the master device via the first bus at a pop rate by the data buffer after the latency period is up.

Preferably, a memory size of the data buffer is smaller than the product of the pop rate and the latency period.

In an embodiment, the controlled device is a chipset, the first bus is a PCI (Peripheral Connect Interface) bus, and the second bus is an AGP (Accelerated Graphics Port) bus. A transmission rate of the AGP bus is greater than that of the PCI bus. The adapter device is an adapter chip electrically connected between the PCI bus and the AGP bus.

Preferably, the method further comprises a step of rising a flag by the second bus when the controlled device intends to store a second data responding to the second data-reading request into the data buffer via the second bus, while the data buffer is still occupied by the first data responding to the first data-reading request.

Preferably, the data buffer is built in the adapter device.

Another aspect of a data-transmission control method for use in a system comprising a master device, an adapter device, a controlled device, a first bus communicating the master device with the adapter device, a second bus communicating the controlled device with the adapter device, and a data buffer associated with the adapter device according to the present invention comprises the following steps. A first and a second separate data-reading requests are asserted within a latency period. The data-reading requests is asserted to the second bus by the adapter device in response to a reading transaction actuated by the master device, and the latency period correlates to a time period required for the adapter device from the assertion of the first data-reading request to the receipt of data responding to the first data-reading request. The data is stored into the data buffer via the second bus by the controlled device in response to the first data-reading request, and the storing operation of the first data completes before the end of the latency period. Then, the first data is outputted to the master device via the first bus at a pop rate by the data buffer after the latency period is up.

Preferably, a memory size of the data buffer is smaller than the product of the pop rate and the latency period.

Preferably, a flag rises when the controlled device intends to store a data responding to the second data-reading request into the data buffer via the second bus, while the data buffer is still occupied by the data responding to the first data-reading request.

### BRIEF DESCRIPTION OF THE DRAWINGS

The present invention may best be understood through the following description with reference to the accompanying drawings, in which:

FIG. 1 is a functional block diagram schematically showing a conventional circuitry in a computer main board;

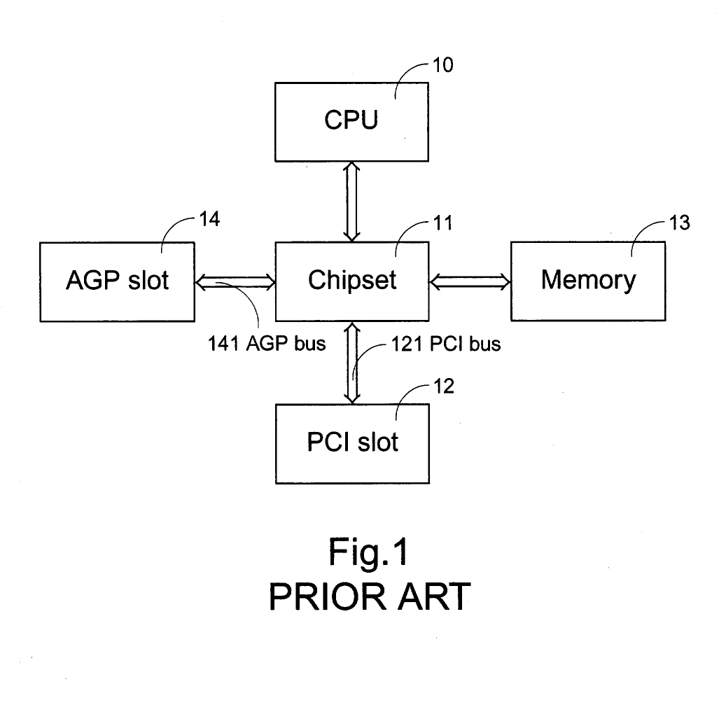

FIG. 2 is a functional block diagram illustrating another conventional circuitry in a computer main board, which has an extensive structure compared to the circuitry of FIG. 1;

FIG. 3 is a sequential waveform diagram schematically showing the signals associated with the data transfer of the devices of FIG. 2 according to prior art; and

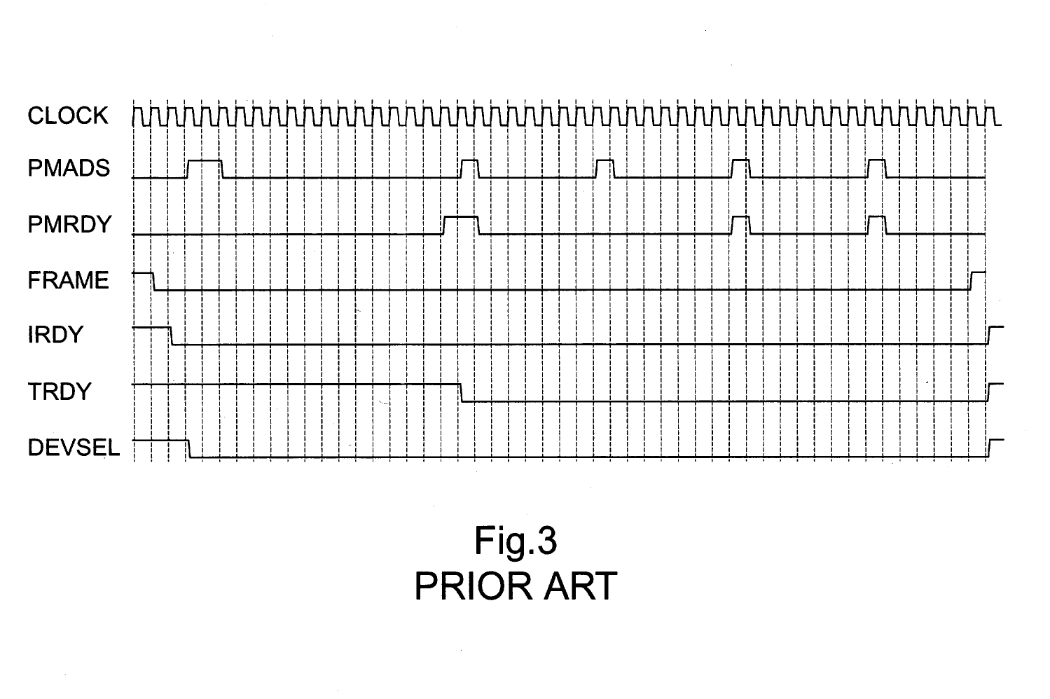

FIG. 4 is a sequential waveform diagram schematically showing the signals associated with the data transfer of the devices of FIG. 2 according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

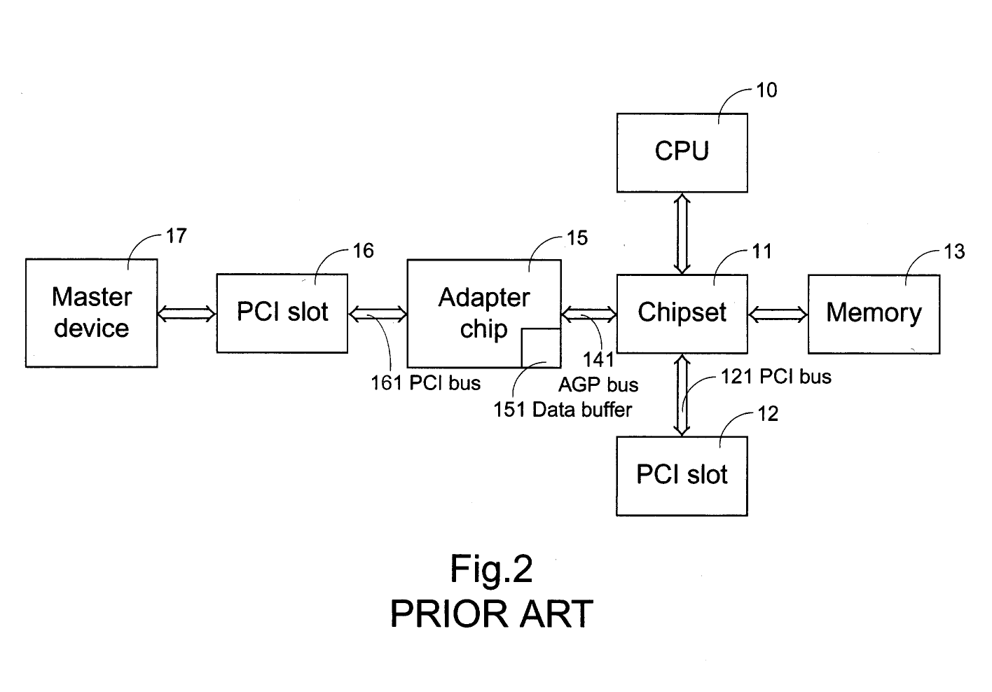

In order to conduct efficient data transmission while saving data-buffer cost, a data-transmission control method is provided and illustrated hereinafter with reference to the devices of FIG. 2.

As is understood from the above description, a latency period in needed for the adapter chip 15 to assert a data-reading request to the chipset 11 in response to the read transaction from the master device 17, and for the chipset 11 to seach the required data from the cache memory of the CPU 10 or DRAM 13, and read and transfer the data to the adapter chip 15 to prepare the PCI bus 161. According to the present method, the interval between two adjacent requests is less than the latency period but greater than zero. After the required data is stored into the data buffer 151 via the AGP bus 141 in response to the data-reading request, the data is outputted to the master device 17 via the PCI bus 161 at the data pop rate of the data buffer 151. By this method, the capacity of the data buffer 151 is not required to be as large as in the prior art.

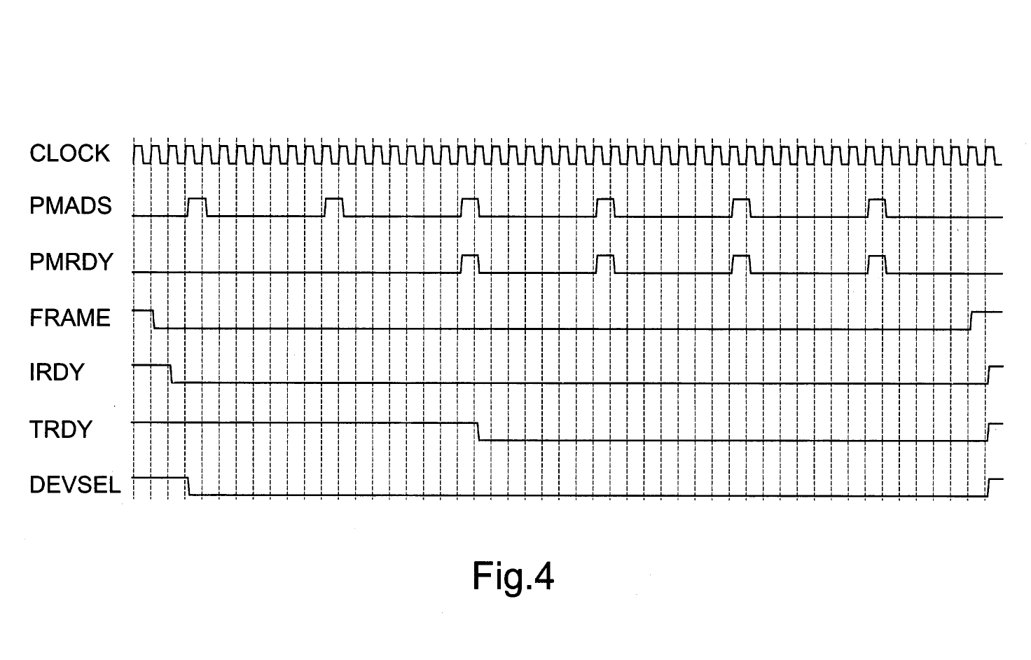

For example, it is assumed that the latency period has a length of 16 clock cycles, the data length to be fetched in response to each request is 8 quadruple word (hereinafter, “QW”), and the rate for the data buffer 151 to transfer the data to the PCI bus 161, or data pop rate, is 1 QW per clock cycle. In this example, a data buffer 151 having a capacity of 8 QW is used. Please refer to FIG. 4 which is a sequential waveform diagram schematically showing the signals associated with the data transfer of the devices of FIG. 2 according to the present invention. When the signals FRAME and IRDY asserted by the master device 17 to the PCI bus 161 are switched from a high level to a low level, it means the master device starts a read transaction and is ready for receiving data. The adapter chip 15 then asserts a device selection signal DEVSEL to the PCI bus 161 and two separate data-reading requests (the first and second high PMADSs) to the AGP bus 141. The two data-reading requests have an interval therebetween less than the latency period. In this example, the interval is 8 clock cycles. By this way, data of 8 QW in length is fetched from the chipset 11 to the data buffer 151 via the AGP bus 141. When the data buffer 151 in the adapter chip 15 receives the data of 8 QW in length after the 16 clock cycles of latency period, referring to the first high PMRDY, the adapter chip 15 informs the PCI bus 161 of the ready status by switching the TRDY signal from a high level to a low level. Meanwhile, the data is transferred from the data buffer 151 to the master device 17 via the PCI bus 161 at a transmission rate of 1 QW per clock cycle. Responding to the latter data-reading request, data of 8 QW in length is fetched by the chipset 11 to the data buffer 151 at 8 clock cycles following the fetching operation responding to the former data-reading request, referring to the second high PMRDY. Meanwhile, the data previously stored in the data buffer 151 is being ouputted at a pop rate of 1 QW per clock cycle. Therefore, some memory space is freed for receiving incoming data responding to the latter request. In order to assure of the safe receipt of all data into the data buffer, when the chipset 11 intends to store data into the data buffer 151 via the AGP bus 141 while the data buffer is still occupied by the preceding data, the AGP bus 141 rises a flag indicative of the buffer-occupied status. Subsequently, the adapter chip 15 asserts another data-reading request (the third, fourth or fifth high PMADS) to the AGP bus 14 every 8 clock cycles to fetch data of 8 QW in length from the chipset 11 to the data buffer 151 via the AGP bus 141. The adapter chip 15 thus continuously transfers data to the master device 17 via the PCI bus 161 at high efficiency.

In accordance with the present method, the required size of data buffer can be reduced to a large extent, e.g. a half size in the above example. On the other hand, the data-transmission efficiency is not affected under such reduced size of the data buffer. As for the selection of the interval between two adjacent data-reading requests, it depends on the latency period, the data length to be fetched responding to each data-reading request, and the data pop rate of the data buffer.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data-transmission control method for use in a system comprising a master device, an adapter device, a controlled device, a first bus communicating said master device with said adapter device, a second bus communicating said controlled device with said adapter device, and a data buffer associated with said adapter device, said method comprising steps of:
asserting a first and a second data-reading requests via said second bus by said adapter device in response to a reading transaction actuated via said first bus by said master device, wherein said first and said second data-reading requests have therebetween a time interval that is greater than zero but less than a latency period indicating when said adapter device asserts said first data-reading request to said controlled device and then receives a required first data to have said first bus ready;
storing said first data into said data buffer via said second bus by said controlled device in response to said first data-reading request, and completing storing said first data before the end of said latency period; and
ouputting said first data to said master device via said first bus at a pop rate by said data buffer after said latency period is up.

2. The method according to claim 1 wherein a memory size of said data buffer is smaller than the product of said pop rate and said latency period.

3. The method according to claim 1 wherein said controlled device is a chipset.

4. The method according to claim 1 wherein a transmission rate of said second bus is greater than that of said first bus.

5. The method according to claim 4 wherein said first bus is a PCI (Peripheral Connect Interface) bus, and said second bus is an AGP (Accelerated Graphics Port) bus.

6. The method according to claim 5 wherein said adapter device is an adapter chip electrically connected between said PCI bus and said AGP bus.

7. The method according to claim 1 further comprising a step of rising a flag by said second bus when said controlled device intends to store a second data responding to said second data-reading request into said data buffer via said second bus, while said data buffer is still occupied by said first data responding to said first data-reading request.

8. The method according to claim 1 wherein said data buffer is built in said adapter device.

9. A data-transmission control method for use in a system comprising a master device, an adapter device, a controlled device, a first bus communicating said master device with said adapter device, a second bus communicating said controlled device with said adapter device, and a data buffer associated with said adapter device, said method comprising steps of:
asserting a first and a second separate data-reading requests within a latency period, wherein said data-reading requests is asserted to said second bus by said adapter device in response to a reading transaction actuated by said master device, and said latency period correlates to a time period required for said adapter device from the assertion of said first data-reading request to the receipt of data responding to said first data-reading request;
storing said data into said data buffer via said second bus by said controlled device in response to said first data-reading request, and completing storing said first data before the end of said latency period; and
ouputting said first data to said master device via said first bus at a pop rate by said data buffer after said latency period is up.

10. The method according to claim 9 wherein a memory size of said data buffer is smaller than the product of said pop rate and said latency period.

11. The method according to claim 9 wherein said controlled device is a chipset.

12. The method according to claim 9 wherein a transmission rate of said second bus is greater than that of said first bus.

13. The method according to claim 12 wherein said first bus is a PCI (Peripheral Connect Interface) bus, and said second bus is an AGP (Accelerated Graphics Port) bus.

14. The method according to claim 13 wherein said adapter device is an adapter chip electrically connected between said PCI bus and said AGP bus.

15. The method according to claim 9 further comprising a step of rising a flag by said second bus when said controlled device intends to store a data responding to said second data-reading request into said data buffer via said second bus, while said data buffer is still occupied by said data responding to said first data-reading request.

16. The method according to claim 9 wherein said data buffer is built in said adapter device.
